(19) United States
(12) Patent Application Publication
(10) Pub. No.: US 2004/0194053 A1
(43) Pub. Date: Sep. 30, 2004

(54) Configuration file processing

(76) Inventor: Erwin R Bonsma, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/480,142

(22) PCT Filed: Jun. 27, 2002
(86) PCT No.: PCT/GB02/02980

(30) Foreign Application Priority Data
Jun. 27, 2001 (GB) 0115690.0

(51) Int. Cl. G06F 9/44

(52) U.S. Cl. 717/100

(57) ABSTRACT

Software object class (9, 10, 13, 14) are provided with methods for roles within a program and methods for processing of a configuration file (6) for the program Accordingly, a first program and second program, which is a configuration utility for the first program, are constructed using the classes so that configuration data can be validated within the first program and during

The present invention relates to a software system.

Many computer programs make use of configuration files to control their behaviour. Often these files are relatively simple and with a little experience, a user can configure a program by editing its configuration file in a text editor. However, the configuration files for some programs are long and complex. The configuration file for Sendmail, for instance, is notoriously arcane. Consequently, many programs are provided with one or more configuration utilities. In order to be really useful, these utilities must present the user with valid options and ensure that the values, selected or entered, for control parameters are sensible in the context of the program being configured. This of course requires the person writing the configuration utility to have fully understood the configuration options of the program to which the configuration utility applies.

Microsoft Windows systems store program configuration data in a database called the Registry and, consequently, there are generally no configuration files that can be edited directly.

It is an aim of the present invention to provide an improved approach to the configuration of computer programs. More particularly, the present invention provides software objects with methods for their role within a program and methods for processing of a configuration file for the program.

According to the present invention, there is provided a software system comprising:

a first program;

a second program; and

a configuration data store storing configuration data for the first program, the second program being a configuration tool for editing said configuration data,

wherein the first and second programs are constructed using a common class, said common class comprising a method for validating configuration data for the first program and a method for providing information regarding the type and/or the valid values for said configuration data for the first program.

The use of the object having the validation function in both programs means that the checks applied by the configuration utility cannot be by-passed by editing the configuration data directly, for example using a text editor.

Preferably, the first program is configured to:

create an instance of said common class, said instance being loaded with configuration data from said configuration data store and validating said data;

create an instance of a further class; and

initialise the instance of said further class using the configuration data loaded into said instance of said common class.

More preferably, the first program is configured to:

create a further instance of said further class; and

initialise the further instance of said further class using the loaded configuration data loaded into said instance of said common class.

More preferably also, the first program is configured to:

create a further instance of said common class, said instance being loaded with a respective set of configuration data from said configuration data store and validating said data;

create a further instance of said further class; and

initialise said further instance of said further class using the configuration data loaded into said further instance of said common class.

Preferably, a system according to the present invention includes a further common class, and the first program and the second program are configured to create respective independent prototype instances of said common classes and the first program is configured to clone an instance of said common class, said cloning including instantiating an instance of the further common class as a member of the cloned instance of said common class.

An embodiment of the present invention will now be described, by way of example, with reference to the accompanying drawings, in which:

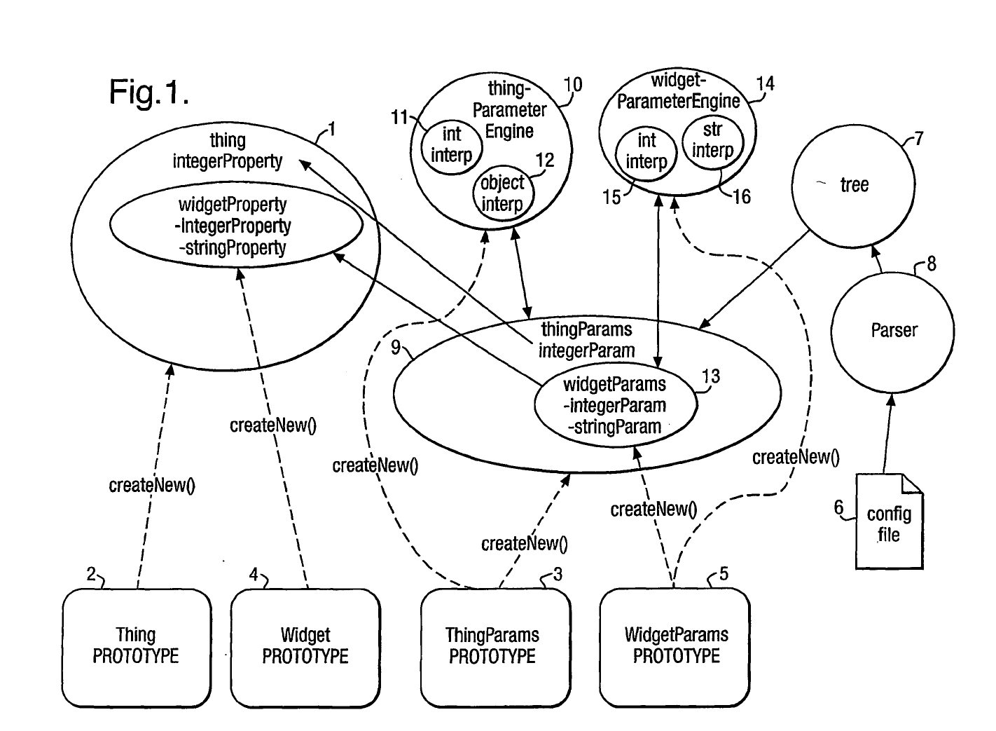

FIG. 1 illustrates the creation of an object in an application program implemented according to the present invention;

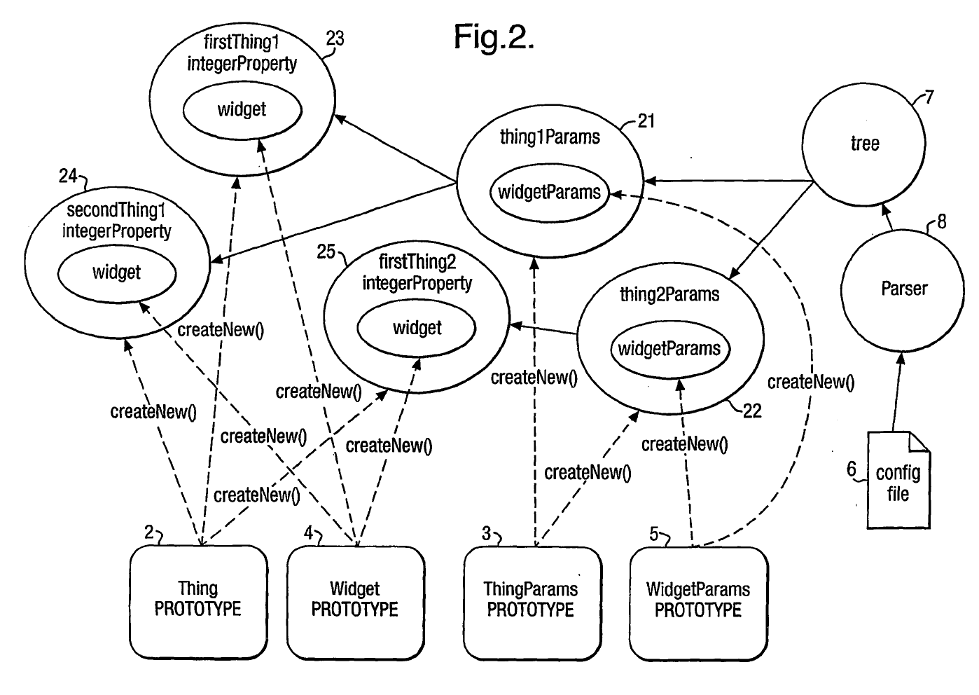

FIG. 2 an application program implemented according to the present invention;

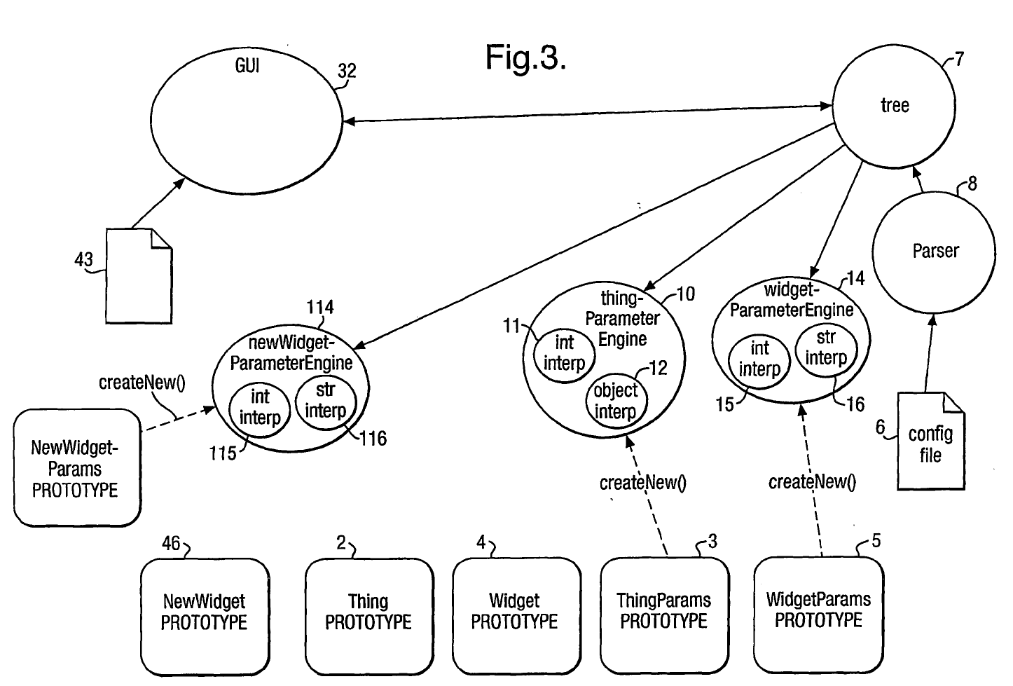

FIG. 3 illustrates a configuration utility program implemented according to the present invention; and

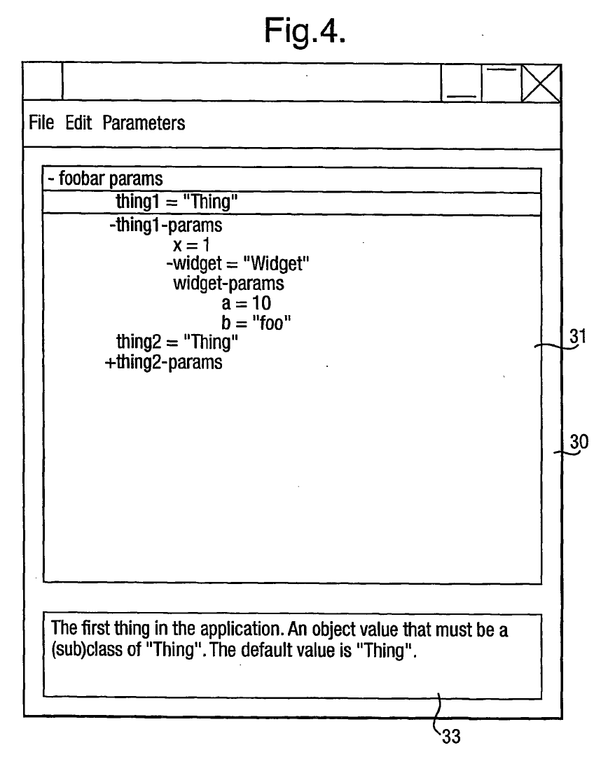

FIGS. 4 to 9 illustrate the user interface of the program of FIG. 3.

The present invention will now be illustrated with reference to a configuration file having the following contents:

```
thing1 = “Thing”;
thing1-params = {
    x = 1;
    widget = “Widget”;
    widget-params = {
        a = 10;
        b = “foo”;
    };
};
thing2 = “Thing”;
thing2-params = {
    x = 2;
    widget = “Widget”;
    widget-params = {
        a = 20;
    };
};
```

This configuration file represents two configurations (“thing1” and “thing2”) for objects of class Thing. Objects of class Thing have two properties, an integer value “x” and an object of class Widget. Objects of the Widget class have two properties also, an integer value “a” and a string value “b”. The first configuration initialises the “x” property to 1. the widget a property to 10 and the widget b property to “foo”. The second configuration similarly initialises the “x” property to 2 and the widget.a property to 20. However, the widget.b property is not defined and will be set to a default value.

The instantiation and configuring of an object of class Thing will now be described with reference to FIG. 1 and in the context of Java.

A feature of Java is that an instance of a class can be made a static final member of its own class using the following form of code:

```
class Aclass implements Cloneable {
    static final Aclass PROTOTYPE = new Aclass( );
    Aclass( ) {
        ...
    };
    Aclass createNew( ) {
        return this.clone( );
    };
}
```

Since the class constructor Aclass is called in the declaration of PROTOTYPE, an instance of Aclass is created when the class is loaded. The createNew method creates a new instance of Aclass and copies the field values of an instance whose clone method is being invoked. Thus a new instance can be created from PROTOTYPE using (Aclass)Aclass.PROTOTYPE.createNew( . . . ).

Referring to FIG. 1, in the present example, four classes including PROTOTYPE class members have been loaded and accordingly there are Thing.PROTOTYPE 2, ThingParams.PROTOTYPE 3, Widget.PROTOTYPE 4 and WidgetParams.PROTOTYPE 5 objects. The ThingParams and WidgetParams classes provide for validation of configuration data obtained from a configuration file 6.

When the program represented in FIG. 1 is run, an instance of a tree object 7 is created. The tree object 7 holds the contents of the configuration file 6 and is loaded by using a method of a Parser object 8. The Parser object method determines whether the configuration file 6 is well-formed but does not validate the data.

In anticipation of the need to create instances of the Thing class, an instance (thingParams) 9 of the ThingParams class is cloned from ThingParams.PROTOTYPE 3.

In the present description, “parameters” are implemented by properties of objects. However, not all object properties are necessarily “parameters”” and not all “parameters” are necessarily properties. For instance, a parameter may be used in the calculation of a randomised value for a property. Parameters are those aspects of an object which a user can control by editing the configuration file 6.

The ThingParams class has an associated ParameterEngine object (“thingParameterEngine”) 10 created by ThingParams.PROTOTYPE. thingParameterEngine 10 includes interpreter objects 11, 12 for integer and object parameters, i.e. properties. The interpreter objects implement the validation of the parameters. The object parameter interpreter 12 is configured in this example to check that the type of object for the Widget parameter, specified in the configuration file, is appropriate, e.g. that it is a descendant of a base Widget class. It does not validate the values of the properties of the widget. However, the instantiation of thingParams 9 includes cloning of a WidgetParams class object (thingParams.widgetParams) 13 from WidgetParams.PROTOTYPE 5. thingParams.widgetParams 13 also has an associated ParameterEngine class object (widgetparameterEngine) 14 which includes integer and string interpreter objects 15, 16 and which is created by WidgetParams.PROTOTYPE.

During construction of thingParams 9 and thingParams.widgetParams 13, the relevant values, taken from the configuration file 6, are loaded into thingParams 9 and thingParams.widgetParams 13 from the tree object 7. These values are validated by the relevant interpreter objects 11, 12, 15, 16 in the relevant ParameterEngine instances 10, 14 and stored in thingParams 9 and include default values for parameters, for use if no value is given in the configuration file 6 as in the case of the “b” parameter for the thing2 configuration, constaints (e.g. maximum and minimum values) and error handling instructions for dealing with invalid values from the configuration files, e.g. error messages.

Thus, thingParams 9 is a repository of validated initial values for the parameters, i.e. at least some fields, of Thing class objects, including parameters of objects contained within Thing class objects.

When an instance (thing) 1 of the Thing class is required in the program represented in FIG. 1, the createNew method of Thing.PROTOTYPE 2 is invoked. The createNew method takes thingParams 9 as a parameter and uses the validated initial values therein to initialise the new object thing 1.

Referring to FIG. 2, in an application controlled by the configuration file illustrated above, two ThingParams objects, thing1Params 21 and thing2Params 22 are created before any new Thing objects are cloned from Thing.PROTOTYPE 2. The thing1Params 21 and thing2Params 22 are cloned from ThingParams.PROTOTYPE 3 using its createNew method and the configuration file data for the “thing1” and “thing2” configurations as parameters respectively. The createNew method consequently loads and validates the parameter values for the identified configuration file entry.

Since, two ThingParams objects 21, 22 have been created, the program logic can be arranged to initialise new Thing objects using one or other of the ThingParams objects 21, 22. In the illustrated example, two Thing objects, firstThing1 and secondThing1 23, 24, are created using

. . .

firstThing1=Thing.PROTOTYPE.createNew(thing1Params)

secondThing1=Thing.PROTOTYPE.createNew(thing1Params)

. . .

and one, firstThing2 25, is created using

. . .

firstThing2=Thing.PROTOTYPE.createNew(thing2Params).

. . .

The method of these objects can be invoked and the values of their properties can be used and altered in the conventional manner according the needs of the program.

In the foregoing, Thing.PROTOTYPE is directly references in the code. However, the prototype created could depend on the parameter type given in the configuration file. In this case, the location of whatever prototype is created would be assigned to a pointer (this is expressed in Java as assignment) and then subsequent code makes use of the pointer's name rather than making a class reference to the PROTYPE static member.

A configuration utility program for generating and modifying the configuration file will now be described.

Referring to FIG. 3, the configuration utility program primarily makes use of Params classes such as the ThingParams and WidgetParams classes and protoypes of the objects being configured.

Referring to FIG. 4, when the configuration utility program is launched, the last used configuration file 6 is loaded and the user may also select a configuration file 6 using the file menu and a file selection dialog in a conventional manner. The selected file 6 is parsed by the Parser 8 and loaded into a tree 7. A view of the tree 7 is provided by a tree view widget 31 in the window 30 of a GUI 32 (FIG. 3). The top level of the tree view widget 31 represents the program, “foobar”, to which the configuration utility relates. The next level of the hierarchy contains the thing configurations comprising the thing types. The thing parameters comprises the next level down and include the widgets whose parameters are in a yet lower level.

During loading of the tree 7, a prototype instance, i.e. Thing.PROTOTYPE And Widget.PROTOTYPE of each object type identified in the tree are created. These are used to obtain the corresponding Params object prototypes, i.e. ThingParams.PROTOTYPE 3 and WidgetParams.PROTOTYPE 5, and the associated parameter engines. Each parameter engine class includes a getParamNames method that returns the names of the parameters that it handles and this method is called for each parameter engine instance 10, 14 to obtain the valid parameter names. Each parameter engine instance 10, 14 also provides some additional information on each parameter handled by it, such as the expected type of its value. Parameters that have invalid names or values of the wrong type are marked in the tree view widget 31 and can be deleted by the user using an edit menu item.

It can be seen that the line in the tree view widget 31 containing the word “thing1” is highlighted and that information regarding “Thing”, the class to which the thing1 configuration applies, is displayed in a text area 38 below the tree view widget 31. This information could be a list of parameter or more general information about the role of the class within the application. When such a line is selected, a getParamInfo method of the relevant parameter engine object 10, 14, which is thingParameterEngine 10 in this case, is called and the text returned is displayed in the text area 33 of the window 30. Similarly, if the “widget” line under “thing1” is selected, a getParamInfo of widgetParameterEngine 14 is invoked to obtain information about the Widget class.

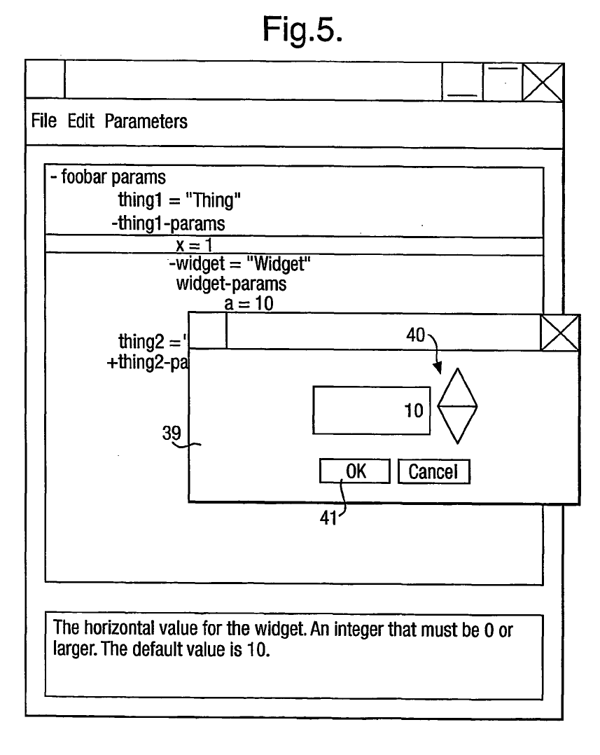

Referring to FIG. 5, in order to change the value of the “x” parameter of the thing1 configuration, the user either double-clicks on its representation in the tree view widget 31 or selects a value change menu option with the thing1 “x” element of the tree view widget 31 selected. This causes a value editing dialog 39 to be displayed. In the illustrated example, the value editing dialog 39 has a spin widget 40 for selecting integer values. The form of the dialog 39 is determined on the basis of the type of the parameter to be edited, obtained, in this example, by invoking a getParamInfo method of thingParameterEngine 10 passing the parameter name “x” as a parameter of the method. The method returns a textual description of the “x” parameter as well as its interpreter 11, which contains its default value as well as the valid range for the value.

When the value editing dialog 39 is closed by clicking on its OK button 41, the tree 7 is updated with the new value. The dialog 39 ensures that the value obeys the constraints embodied by the parameter interpreter for the integer value “x” 11.

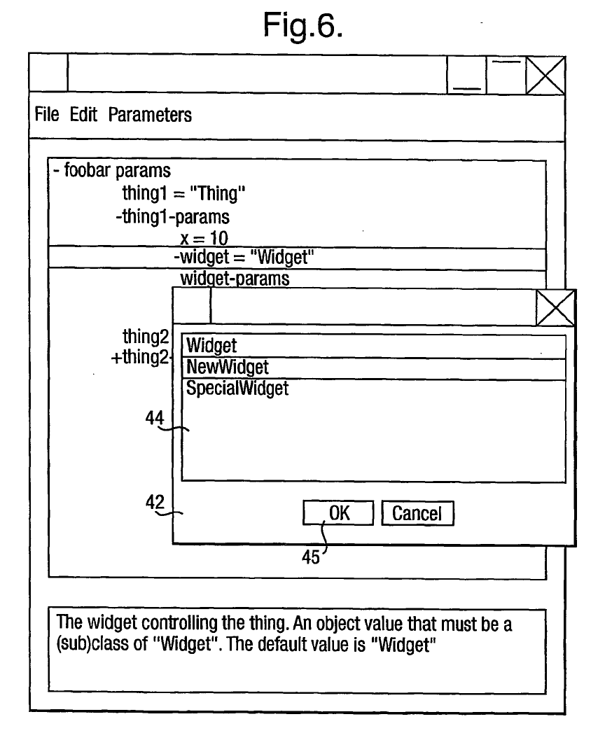

Referring to FIG. 6, in order to change the “widget” parameter of the thing1 configuration, the user either double-clicks on its representation in the tree view widget 31 or selects a value change menu option with the thing1 “widget” element of the tree view widget 31 selected. This causes an object parameter selection dialog 42 to be displayed.

Before the object parameter selection dialog 42 is displayed, the required base class of the widget parameter is obtained from thingParameterEngine 10 using the getParamInfo method and a search of the Java classpath for files for the Widget class and classes descended from the Widget class is carried out to locate suitable options. The entire classpath in not searched as this would be time consuming and unnecessary. Instead, a file 43 is used to define the scope of the search. The file 43 contains a list of the class files through which to search and provides alias for identifying classes to avoid the use of the unwieldy full class identifiers in the user interface. The aliases of the located classes are displayed in list box 44 in the object parameter selection dialog 42. In the present example, three suitable classes have been located.

When the object selection dialog 42 is closed by clicking on its OK button 45, the selected object prototype (NewWidget.PROTOTYPE 46) is used to obtain the corresponding parameter prototype (NewWidgetPararns.PROTOTYPE 47). The getParamNames method of the newWidgetParameterEngine 114 is called and any parameters in the tree 7 which are not recognised are marked as unknown. newWidgetParameterEngine includes first to third interpreters 115, 116, 117 for parameters “a”, “b” and “c” respectively. The first and second interpreters 115, 116 are respectively integer and string interpreters. The third interpreter 117 is a mapping interpreter which is used where a parameter must have a value belonging to a defined set of values, e.g. a set comprising the colours “red”, “green” and “blue”.

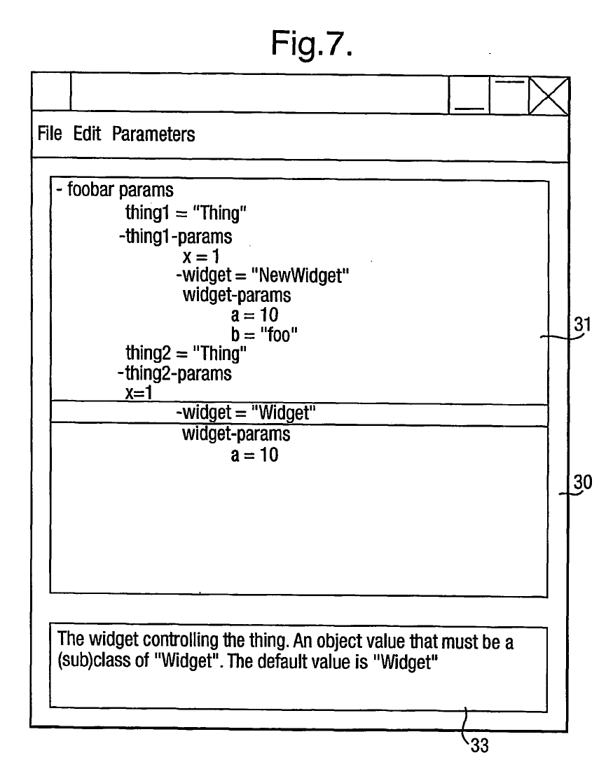

Referring to FIG. 7, it can be seen that the “widget” parameter of thing1 is now of type NewWidget and that the tree has been expanded so show the parameters of thing2. Since the confirmation file 6 did not have an entry for the “b” parameter of the “widget” parameter of thing2, only the “a” parameter is shown. This means that the “b” parameter would be controlled by the default value defined in widgetParameterEngine 14.

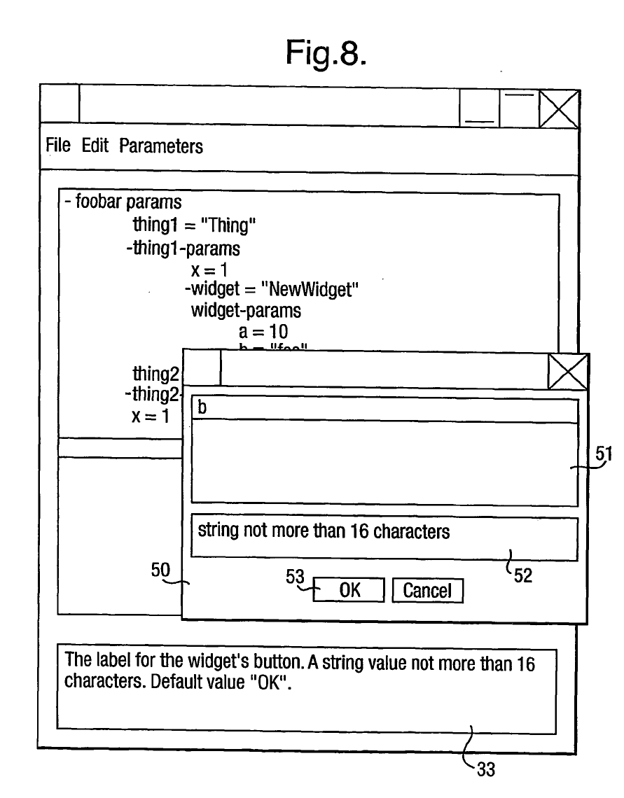

Referring to FIG. 8, in order to set a value for the “b” parameter of the widget parameter of thing2, the user selects an add parameter menu option with the thing2 widget element of the tree view widget 31 selected. This causes an add parameter dialog 50 to be displayed. The getParamNames method of widgetParameterEngine 14 is invoked to obtain the names of the parameters of the Widget class, for which values have not yet been set, and these are displayed in a list box 51 in the add parameter dialog 50. When the user selects on of the displayed parameters, the getParamInfo method is invoked to obtain information about the selected parameter and the descriptive part of the returned information is displayed in a text area 52 below the list box 51.

When the user clicks on the OK button 53 of the add parameter dialog 50, the selected parameter is added to the tree 7 and displayed in the tree view widget 31. At this point, the added parameter is given its default value. The user can change the value for the added parameter as described above with reference to the “x” parameter of the thing1 configuration.

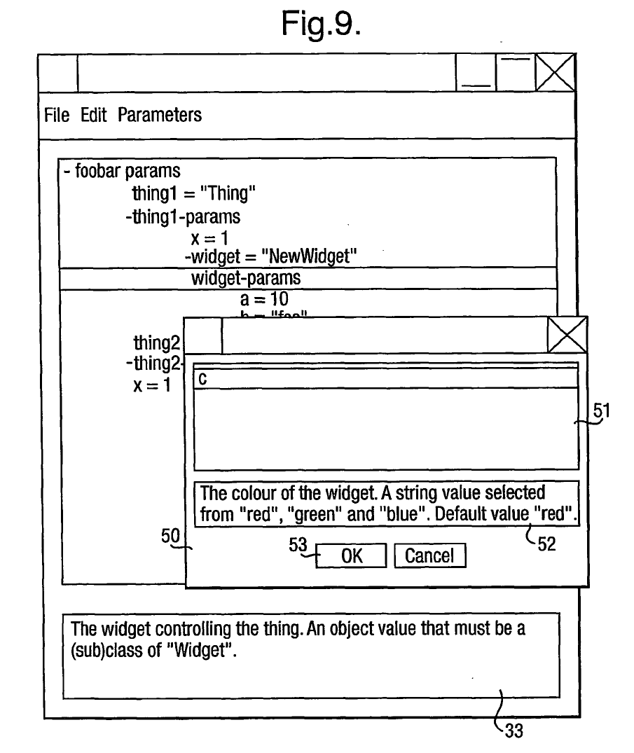

Referring to FIG. 9, it can be seen that the NewWidget class has one more parameter, i.e. “c”, than the Widget class. When Widget was changed to NewWidget, the extra parameter was not displayed or included in the tree 7 and would therefore take its default value defined in NewWidgetParams. Therefore, the user needs to add “c” in order to control its value as described above with reference to FIG. 8.

By selecting the appropriate menu item, a user can validate the parameter values in the tree object 7. This is done by trying to create properly initialised parameter objects (not shown) from the tree 7 by invoking the createNew methods of the corresponding prototypes 3,5, 47 and passing the relevant parameters from the tree object 7. The createNew methods invoke interpret methods on each associated interpreter, passing it the relevant of the data in the tree object. When a parameter value is invalid according to an interpreter, an error is generated which includes the source and description of the error. The initialisation of the parameter object aborts and the error can be shown to the user.

As well as using the interpreters' interpret methods to validate parameters separately, the createNew method also checks that combinations of parameter values are valid. To take an arbitrary example, NewWidgetParams might implement a rule that did not allow “c” to be “red” if “a” is less than 20.

When a user is satisfied with the configuration data in the tree, the user saves it to the configuration file 6 by selecting a save menu item or closing the configuration utility.

Returning now to the interpreters 11, 12, 15, 16, since Java permits function overloading, the interpreter classes have a plurality of constructors which take different sets of parameters. The particular constructor used is a choice for the person writing the parameter engine creating method of a Params class. The most complex integer interpreter constructor takes a name string for finding the correct parameter value in a tree object, a default value, a minimum value and a maximum value to be returned by the getParamInfo method mentioned above. The most complex string constructor takes a name string and a default value. A mapped value interpreter is used to constrain values to a predetermined set of options. The mapping is in the form of a hash that is passed to the mapping interpreter constructor along with the name string and a default value. The constructor for an object interpreter takes a name string, a default class and an ancestor class from which it must descend. It can be seen that similar arrangements can be created for other parameter types.

The descriptive information returned by the above-mentioned getParamInfo methods is held in the parameter engines separate from the interpreters.

New classes can be derived from existing classes, e.g. NewWidget from Widget, and at the same time a new Params class derived, e.g. NewWidgetParams from WidgetParams. By default, a derived Params class will have an empty parameter. engine that simply refers to the parameter engine of its super class for all parameter support. However, new interpreters can be added to the parameter engine to support additional parameters, or to change how existing parameters are handled, e.g. their default value.

The present invention is particularly applicable to programs implementing evolutionary algorithms in which population and individual objects need to be initialised with different parameter and it is desirable to avoid having to write a new descendant class for the program. Furthermore, configuring instances of newly developed classes, possibly developed elsewhere, is made easy because the configuration utility is inherently able to provide support to the user regarding the parameters that can be specified. Other applications are in setting user preferences for GUIs and in games for defining the characteristics of characters so that a single character class can be used to implement all possible characters that users can define. The implementation of rules defining valid combinations of parameters is useful in this respect as a game may not play well if, for example, a character can both fly and turn opponents to stone in combat situations.

It will be appreciated that the present invention allows for many modifications to the embodiment described above. For instance, an object may have a list of arbitrary length of parameters and a parameter that defines the length of the list.

1. A software system comprising:
a first program;
a second program; and
a configuration data store storing configuration data for the first program, the second program being a configuration tool for editing said configuration data,
wherein the first and second programs are constructed using a common class, said common class comprising a method for validating configuration data for the first program and a method for providing information regarding the type and/or the valid values for said configuration data for the first program.

2. A software system according to claim 1, wherein the first program is configured to:
create an instance of said common class, said instance being loaded with configuration data from said configuration data store and validating said data;
create an instance of a further class; and
initialise the instance of said further class using the configuration data loaded into said instance of said common class.

3. A software system according to claim 2, wherein the first program is configured to:
create a further instance of said further class; and
initialise the further instance of said further class using the loaded configuration data loaded into said instance of said common class.

4. A software system according to claim 2 or 3, wherein the first program is configured to:
create a further instance of said common class, said instance being loaded with a respective set of configuration data from said configuration data store and validating said data;
create a further instance of said further class; and
initialise said further instance of said further class using the configuration data loaded into said further instance of said common class.

5. A software system according to any preceding claim, including a further common class, wherein the first program and the second program are configured to create respective independent prototype instances of said common classes and the first program is configured to clone an instance of said common class, said cloning including instantiating an instance of the further common class as a member of the cloned instance of said common class.
